(19) United States
(12) Patent Application Publication
(10) Pub. No.: US 2007/0272720 A1
(43) Pub. Date: Nov. 29, 2007

(54) PARTIALLY-FORMED STAPLE SHEET AND STAPLER FOR USING SAME

(75) Inventor: David P. Adams, Barrington, IL (US)

Correspondence Address: MICHAEL BEST & FRIEDRICH LLP, 100 EAST WISCONSIN AVENUE, SUITE 3300, MILWAUKEE, WI, 53202, US

(73) Assignee: ACCO BRANDS USA LLC, Lincolnshire, IL (US)

(21) Appl. No.: 11/688,355

(22) Filed: Mar. 20, 2007

Related U.S. Application Data
(60) Provisional application No. 60/747,967, filed on May 23, 2006.

(51) Int. Cl. B25C 5/04; F16B 15/08

(52) U.S. Cl. 227/85; 411/443

(57) ABSTRACT

The present invention provides a sheet of partially-formed staple blanks, stacked sheets of partially-formed staple blanks, and a stapler for receiving the stacked sheets. Each blank defines a crown portion lying in a crown plane, a first leg portion connected to a first end of the crown portion and lying in a first leg plane forming an angle with the crown plane between about 5 degrees and about 50 degrees, and a second leg portion connected to a second end of the crown portion and lying in a second leg plane different from the first leg plane and forming an angle with the crown plane between about 5 degrees and about 50 degrees. The first leg portions of the blanks are attached to one another in the first leg plane, and the second leg portions of the blanks are attached to one another in the second leg plane.

### RELATED APPLICATIONS

This application claims priority to U.S. Provisional Patent Application Ser. No. 60/747,967 filed on May 23, 2006, the entire contents of which is incorporated herein by reference.

### FIELD OF THE INVENTION

The present invention relates to staplers, and more particularly to sheets of staple blanks utilized in staplers.

### BACKGROUND OF THE INVENTION

Cartridge staples are commonly formed from staple blanks into sheet stacks or rolls. This allows much greater staple density and reduced reload frequency versus common sticks of fully formed staples. Most often, staple blanks take the form of a straight wire, and a former assembly of a stapler forms the staple blank into the conventional staple shape before driving it into a stack of papers. Sheets of straight wire staple blanks contact each other for substantially their entire length when assembled into a sheet stack. Staple blanks may also take the form of a partially-formed blank, having one or more existing bends often corresponding with portions of the staple blank that are acted upon by the former assembly. Such partially-formed staple blanks previously were comprised of attached leg portions that lie in a common plane, attached crown portions with unattached legs to form a roll of partially-formed staple blanks, or relatively large angles between the leg portions and the crown portions (e.g., 60 degrees) that would allow penetration without requiring an intermittent forming step.

### SUMMARY OF THE INVENTION

Partially-formed staple blanks, compared to straight-wire staple blanks, require a reduced amount of force to form the blanks into their final form. As such, a stapler containing the partially-formed staple blanks may require a reduced amount of energy to form and drive the partially-formed staple blanks. In addition, when the partially-formed staple blanks are attached along their non-parallel leg portions, sheets of partially-formed staple blanks may not be rolled for storage in a stapler. Rather, sheets of partially-formed staple blanks may be nested in a stapler when the leg portions of the blanks define angles between about 5 degrees and about 85 degrees relative to the crown portions. More sheets, however, may be nested within a stapler when the angles between the leg portions and the crown portions become smaller.

The sheets of partially-formed staple blanks are more structurally rigid, and therefore stronger, than sheets of straight-wire staple blanks. Straight-wire staple blanks are attached to each other in a single plane, which may allow a sheet of straight-wire staple blanks to distort during manufacturing or handling. Distorted sheets of straight-wire staple blanks may be unfit for use because they may not fit properly within the magazine or cartridge of the stapler, or they may cause problems (e.g., jamming or misfires) during stapling operations.

The partially-formed staple blanks of the present invention, however, are attached to each other in more than one plane. Such “multi-plane rigidity” results in a better ability to hold the tolerances of the sheets of partially-formed staple blanks, and therefore reduce or substantially eliminate distortion of sheets of the partially-formed staple blanks during manufacturing and handling. This helps ensure that the sheets of partially-formed staple blanks fit within the magazine or cartridge of the stapler and provide smooth and reliable stapling operations. Furthermore, the stapler that accepts the partially formed staple sheets of the invention can be more tolerant of variation in the staple blanks due to the multiple planes of guidance that can be employed due to the multiple planes of rigidity found in the inventive partially-formed staple blanks.

Depending on the configuration of the crown to leg angles of the present invention, a gap may be created between the staple blank crowns when nested in a sheet stack, thereby greatly reducing the friction between sheets. Straight wire staple sheets press directly against each other for essentially their entire length creating feed resistance and difficulty separating sheets in a stack. Further, the stapler that accepts the partially-formed staple sheets of the invention can employ a more reliable feed system by making use of any resulting crown gap between the inventive sheets within a nested stack.

The present invention provides, in one aspect, a sheet of partially-formed staple blanks including a first partially-formed staple blank defining a crown portion lying in a crown plane, a first leg portion connected to a first end of the crown portion and lying in a first leg plane forming an angle with the crown plane between about 5 degrees and about 50 degrees, and a second leg portion connected to a second end of the crown portion and lying in a second leg plane different from the first leg plane and forming an angle with the crown plane between about 5 degrees and about 50 degrees. The sheet also includes a second partially-formed staple blank defining a crown portion lying in the crown plane, a first leg portion connected to a first end of the crown portion and lying in the first leg plane, and a second leg portion connected to a second end of the crown portion and lying in the second leg plane. The first leg portions of the first and second blanks are attached to one another, and the second leg portions of the first and second blanks are attached to one another.

The present invention provides, in another aspect, an assembly of stacked sheets of partially-formed staple blanks. The assembly includes a first sheet of partially-formed staple blanks including a crown section lying in a crown plane and containing a plurality of crown portions of staple blanks in the first sheet, and a first leg section adjacent the crown section, lying in a first leg plane, and containing a plurality of attached first leg portions of the staple blanks in the first sheet. The first leg plane forms an angle with the crown plane between about 5 degrees and about 85 degrees. The first sheet also includes a second leg section adjacent the crown section, lying in a second leg plane different from the first leg plane, and containing a plurality of attached second leg portions of the staple blanks in the first sheet. The second leg plane forms an angle with the crown plane between about 5 degrees and about 85 degrees. The assembly also includes a second sheet of partially-formed staple blanks substantially identical to the first sheet of partially-formed staple blanks. The second sheet of partially-formed staple blanks is in nested relation with the first sheet of partially-formed staple blanks.

The present invention provides, in yet another aspect, a stapler for stapling the inventive sheets of partially-formed staple blanks. The stapler includes a sheet of partially-formed staple blanks, a staple feeding mechanism that feeds the sheet of partially-formed staple blanks in a staple feed direction, and a staple former assembly. The sheet of partially-formed staple blanks includes a first partially-formed staple blank defining a crown portion lying in a crown plane, a first leg portion connected to a first end of the crown portion and lying in a first leg plane, and a second leg portion connected to a second end of the crown portion and lying in a second leg plane different from the first leg plane. The sheet also includes a second partially-formed staple blank defining a crown portion lying in the crown plane, a first leg portion connected to a first end of the crown portion and lying in the first leg plane, and a second leg portion connected to a second end of the crown portion and lying in the second leg plane. The staple former assembly may bend the first leg portions of the staple blanks to an angle of about 90 degrees between the first leg portions and the crown portions, and the second leg portions of the staple blanks to an angle of about 90 degrees between the second leg portions and the crown portions.

The present invention provides, in yet another aspect, a method of stapling stacked sheets. The method includes providing a first partially-formed staple blank defining a crown portion lying in a crown plane, a first leg portion connected to a first end of the crown portion and lying in a first leg plane forming an angle with the crown plane of at least about 5 degrees, and a second leg portion connected to a second end of the crown portion and lying in a second leg plane different from the first leg plane and forming an angle with the crown plane of at least about 5 degrees. The method also includes providing a second partially-formed staple blank defining a crown portion lying in the crown plane, a first leg portion connected to a first end of the crown portion and lying in the first leg plane, and a second leg portion connected to a second end of the crown portion and lying in the second leg plane. The method further includes attaching the first leg portions of the first and second blanks to one another, attaching the second leg portions of the first and second blanks to one another, forming the first and second leg portions of the first partially-formed staple blank to be substantially perpendicular to the crown portion of the first partially-formed staple blank, and driving the formed first staple blank into the stacked sheets.

Other aspects of the invention will become apparent by consideration of the detailed description and accompanying drawings.

### BRIEF DESCRIPTION OF THE DRAWINGS

FIG. 1a is a front perspective view of nested sheets of partially-formed single crown staple blanks having a first configuration.

FIG. 1b is a front perspective view of nested sheets of partially-formed single crown staple blanks having a second configuration.

FIG. 1c is a front perspective view of nested sheets of partially-formed single crown staple blanks having a third configuration.

FIG. 1d is a front perspective view of nested sheets of partially-formed single crown staple blanks having a fourth configuration.

FIG. 1e is a front perspective view of nested sheets of partially-formed single crown staple blanks having a fifth configuration.

FIG. 2a is an enlarged, front view of the nested sheets of FIG. 1a.

FIG. 2b is an enlarged, front view of the nested sheets of FIG. 1b.

FIG. 2c is an enlarged, front view of the nested sheets of FIG. 1c.

FIG. 2d is an enlarged, front view of the nested sheets of FIG. 1d.

FIG. 2e is an enlarged, front view of the nested sheets of FIG. 1e.

FIG. 3a is a front perspective view of nested sheets of partially-formed double crown staple blanks having a first configuration.

FIG. 3b is a front perspective view of nested sheets of partially-formed double crown staple blanks having a second configuration.

FIG. 3c is a front perspective view of nested sheets of partially-formed double crown staple blanks having a third configuration.

FIG. 3d is a front perspective view of nested sheets of partially-formed double crown staple blanks having a fourth configuration.

FIG. 4a is an enlarged, front view of the nested sheets of FIG. 3a.

FIG. 4b is an enlarged, front view of the nested sheets of FIG. 3b.

FIG. 4c is an enlarged, front view of the nested sheets of FIG. 3c.

FIG. 4d is an enlarged, front view of the nested sheets of FIG. 3d.

FIG. 5a is an enlarged, top perspective view of a sheet of partially-formed single crown staple blanks of FIG. 1a, illustrating beads of adhesive attaching adjacent staple blanks along leg portions of the staple blanks.

FIG. 5b is an enlarged, top perspective view of a sheet of partially-formed single crown staple blanks of FIG. 1a, illustrating a bead of adhesive attaching adjacent staple blanks along the entire edges of the staple blanks.

FIG. 5c is a top perspective view of a sheet of partially-formed single crown staple blanks of FIG.1 a, illustrating a strip of adhesive attaching adjacent staple blanks along leg portions of the staple blanks.

FIG. 5d is a top perspective view of a sheet of partially-formed single crown staple blanks of FIG. 1a, illustrating strips of adhesive attaching adjacent staple blanks along crown portions and leg portions of the staple blanks.

FIG. 6 is a perspective view of an electric stapler having an adjustable former assembly utilizing the sheets of partially-formed double crown staple blanks of FIG. 3a.

FIG. 7 is a perspective view of a manual stapler utilizing the sheets of partially-formed single crown staple blanks of FIG. 1a.

FIG. 8a is a schematic view illustrating the forming action of the partially-formed single crown staple blanks of FIG. 1a.

FIG. 8b is a schematic view illustrating the forming action of the partially-formed single crown staple blanks in combination with an adjustable former, the formed staple having a newly formed crown portion wider than the crown portion of the staple blank.

FIG. 9a is a schematic view illustrating the forming action of the partially-formed double crown staple blanks of FIG. 3a in combination with an adjustable former, the formed staple having a wide crown portion and short leg portions.

FIG. 9b is a schematic view illustrating the forming action of the partially-formed double crown staple blanks of FIG. 3a in combination with an adjustable former, the formed staple having a narrow crown portion and long leg portions.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

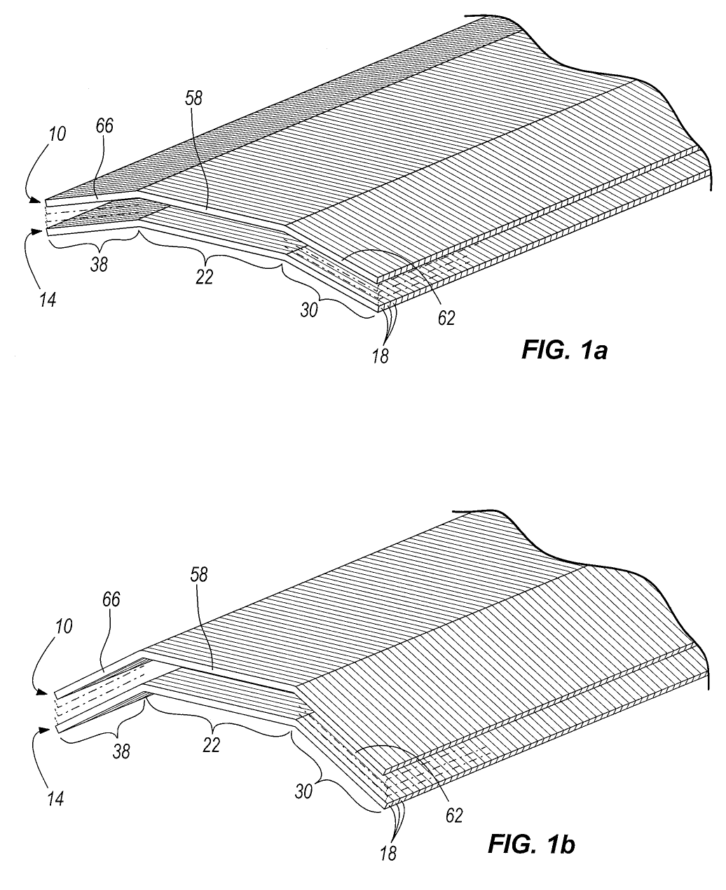

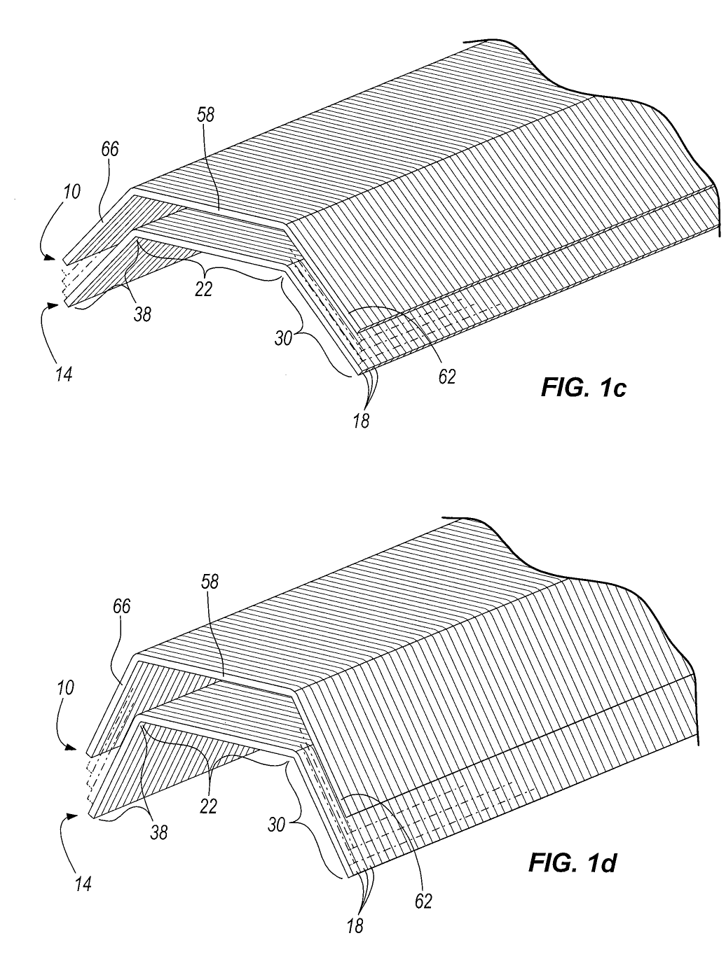

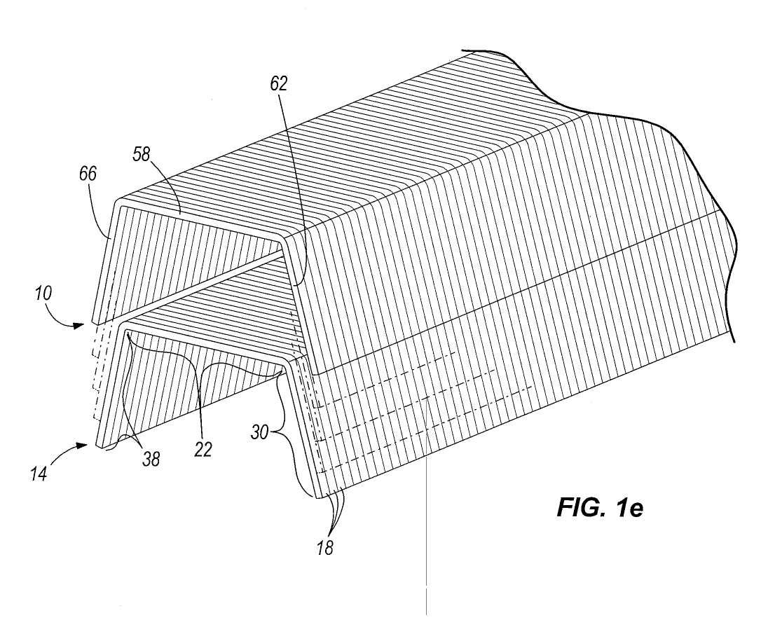

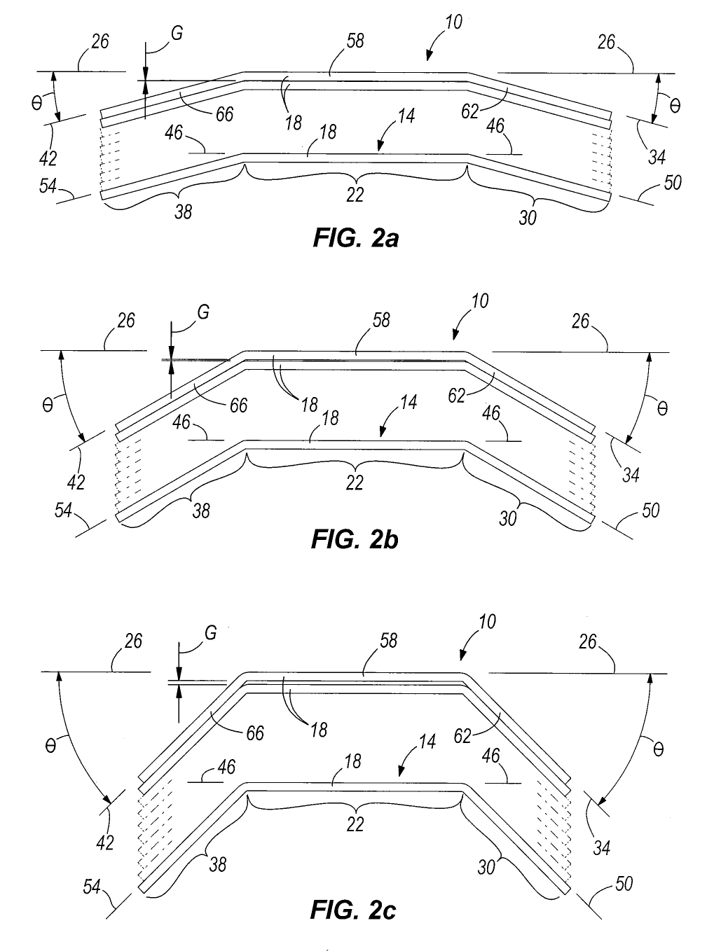

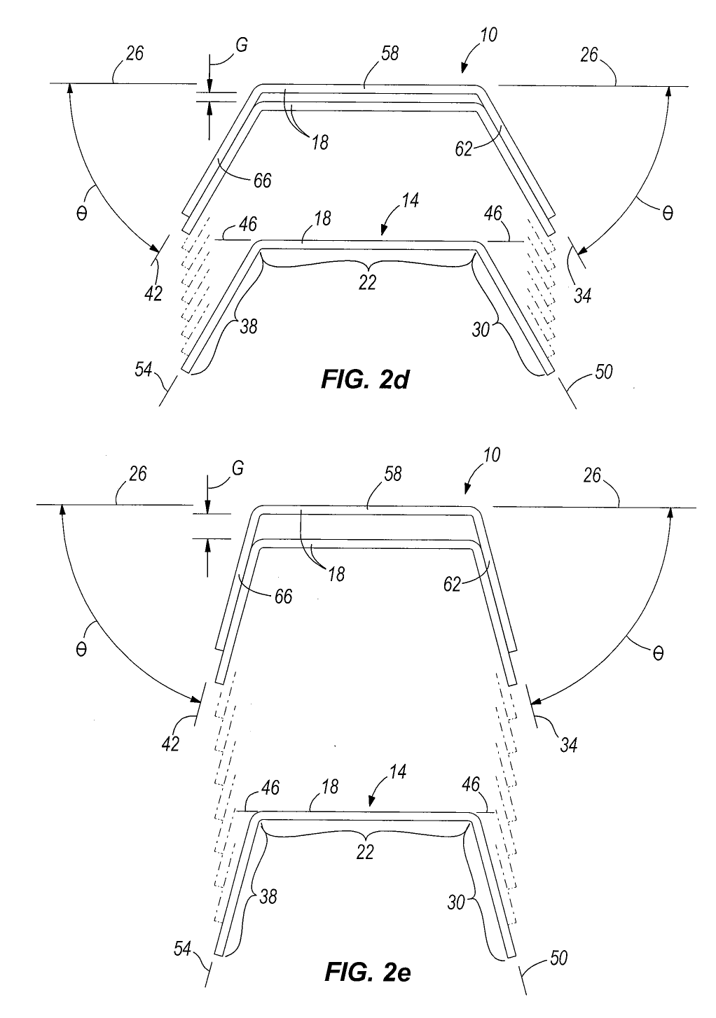

FIGS. 1a-1e illustrate various configurations of stacked or nested sheets 10, 14 of partially-formed single crown staple blanks 18. With reference to FIGS. 1a and 2a, a first sheet 10 includes a crown section 22 lying in a crown plane or a first plane 26, a first leg section 30 adjacent the crown section 22 and lying in a first leg plane or a second plane 34, and a second leg section 38 adjacent the crown section 22 and lying in a second leg plane or a third plane 42. A second sheet 14 substantially similar to the first sheet 10 may be directly nested with the first sheet 10 or indirectly nested via one or more intermediate sheets. The second sheet 14 includes the crown section 22 lying in a fourth plane 46 substantially parallel to and spaced from the first plane 26, the first leg section 30 lying in a fifth plane 50 substantially parallel to and spaced from the second plane 34, and the second leg section 38 lying in a sixth plane 54 substantially parallel to and spaced from the third plane 42.

With continued reference to FIGS. 1a and 2a, the crown sections 22 of the sheets 10, 14 include a plurality of central or crown portions 58 of the staple blanks 18. The first leg sections 30 of the sheets 10, 14 include a plurality of first leg portions 62 of the staple blanks 18. The first leg portions 62 are connected to the crown portions 58 of the staple blanks 18 at one end of the crown portions 58. The second leg sections 38 of the sheets 10, 14 include a plurality of second leg portions 66 of the staple blanks 18. The second leg portions 66 are connected to the crown portions 58 of the staple blanks 18 at an end of the crown portions 58 opposite the first leg portions 62.

With reference to the first sheet 10 in FIGS. 2a-2e, the second plane 34 containing the first leg portions 62 of the staple blanks 18 forms an angle θ with the first plane 26 containing the crown portions 58 of the staple blanks 18. In addition, in the illustrated embodiment the third plane 42 containing the second leg portions 66 of the staple blanks 18 forms the same angle θ with the first plane 26, however, the angles θ need not be the same. As shown in FIGS. 2a-2e, the staple blanks 18 may be partially-formed such that the angle θ is between about 5 degrees and about 85 degrees, and in some embodiments, between about 5 degrees and about 50 degrees. Particularly, FIG. 2a illustrates a configuration of the staple blanks 18 having an angle θ between about 5 degrees and about 25 degrees, and preferably equal to about 15 degrees. FIG. 2b illustrates a configuration of the staple blanks 18 having an angle θ between about 20 degrees and about 40 degrees, and preferably equal to about 30 degrees. FIG. 2c illustrates a configuration of the staple blanks 18 having an angle θ between about 35 degrees and about 55 degrees, and preferably equal to about 45 degrees. FIG. 2d illustrates a configuration of the staple blanks 18 having an angle θ between about 50 degrees and about 70 degrees, and preferably equal to about 60 degrees. FIG. 2e illustrates a configuration of the staple blanks 18 having an angle θ between about 65 degrees and about 85 degrees, and preferably equal to about 75 degrees.

With continued reference to FIGS. 2a-2b, the first leg sections 30 of adjacent sheets 10, 14 directly contact one another when the sheets 10, 14 are stacked or nested. Likewise, the second leg sections 38 of adjacent sheets 10, 14 directly contact one another when the sheets 10, 14 are stacked or nested. However, the crown sections 22 of adjacent sheets 10, 14 are spaced from one another by a gap “G” when the sheets 10, 14 are stacked or nested resulting in less feeding friction between adjacent sheets 10, 14. Comparing the configurations of the nested sheets 10, 14 in FIGS. 2a-2b, the gap G increases as the angle θ increases. As the angle θ increases, less force is required to bend the staple blanks 18 into their final form (i.e., bending the leg portions 62, 66 substantially perpendicular to the crown portion 58). Also, as the angle θ increases, the structural rigidity of the sheets 10, 14 increases. As the gap G increases, the stapler feeding system may be adapted to use the height difference provided and/or to enter into gap G providing a more reliable feeding action and generally requiring a less complex feeding system. However, as the angle θ increases, fewer sheets 10, 14 may be nested within a fixed storage space in a stapler.

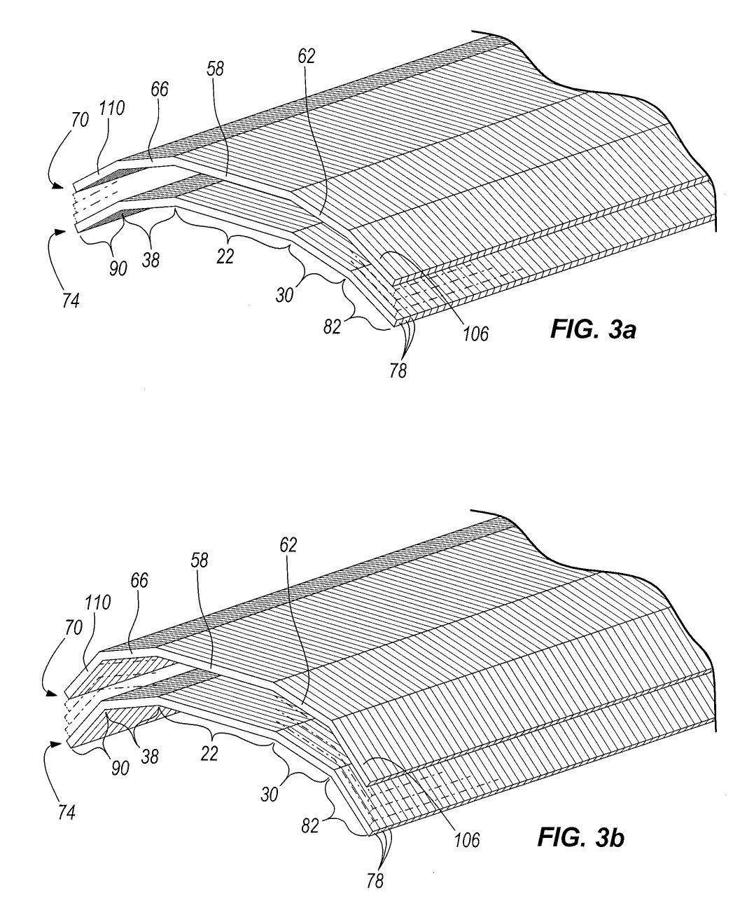

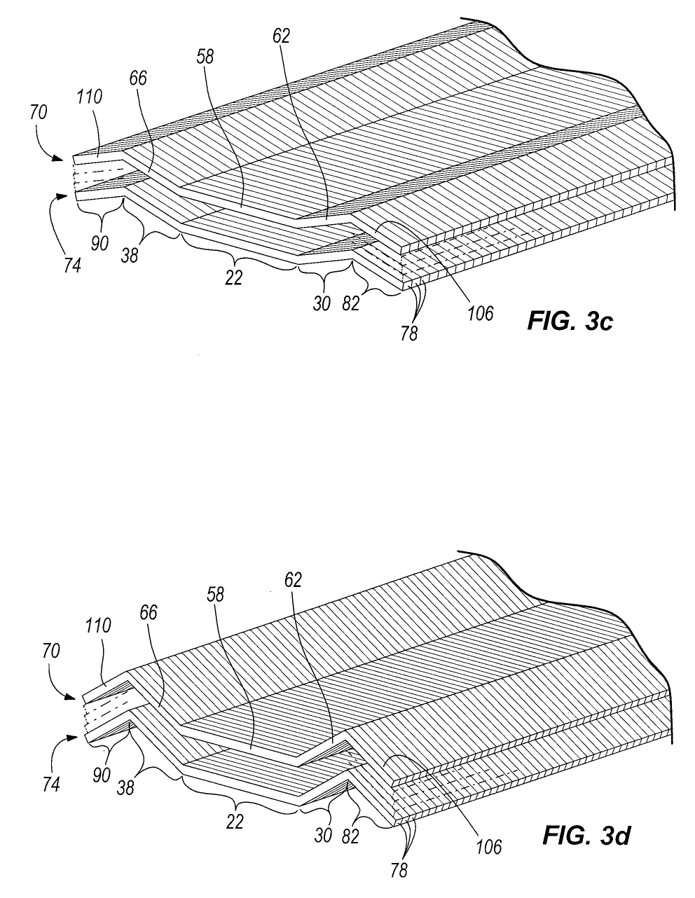

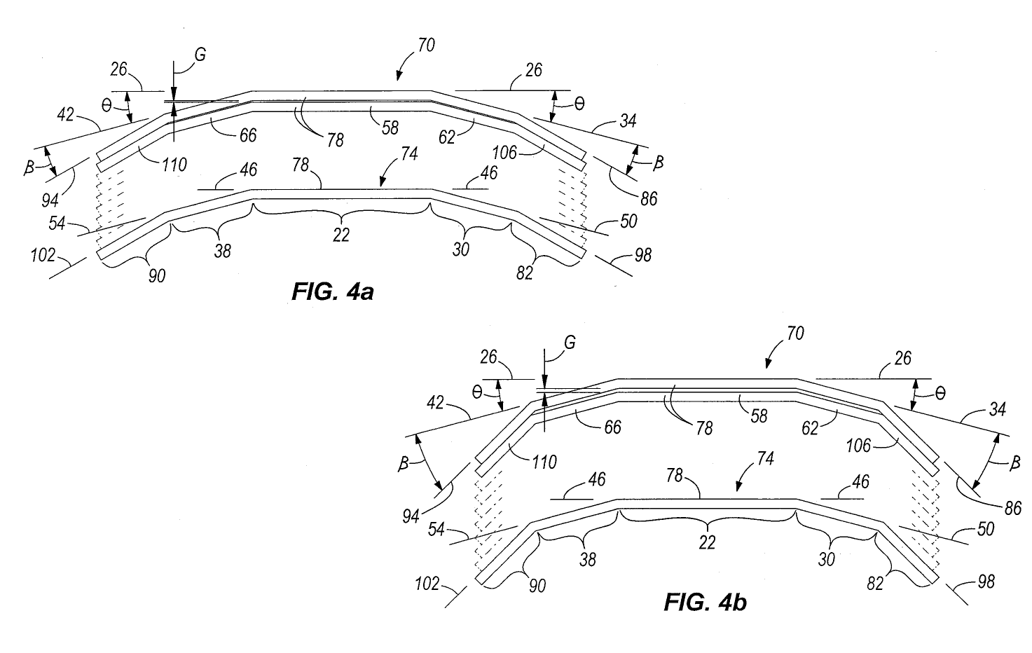

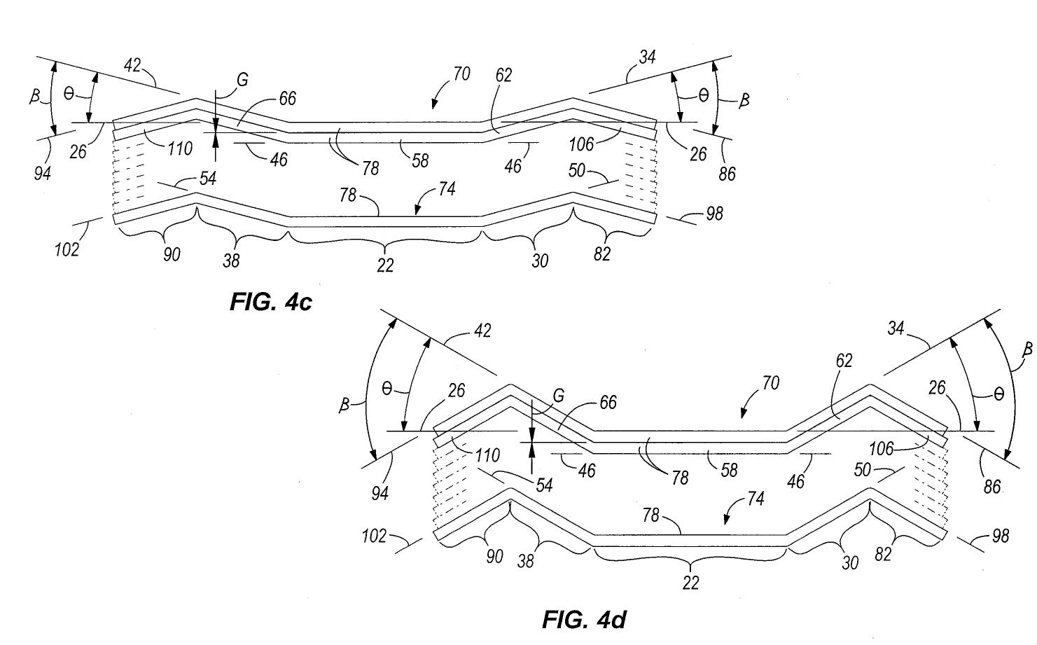

FIGS. 3a-3d illustrate various configurations of stacked or nested sheets 70, 74 of partially-formed double crown staple blanks 78. With reference to FIGS. 3a and 4a, a first sheet 70 includes the previously described crown section 22 having the crown portions 58, the first leg section 30 having the first leg portions 62, and the second leg section 38 having the second leg portions 66. Additionally, the first sheet 70 includes a third leg section 82 adjacent the first leg section 30 and lying in a seventh plane 86, and a fourth leg section 90 adjacent the second leg section 38 and lying in an eighth plane 94. A second sheet 74 substantially similar to the first sheet 70 may be directly nested with the first sheet 70 or indirectly nested via one or more intermediate sheets. The second sheet 74 additionally includes the third leg section 82 lying in a ninth plane 98 substantially parallel to and spaced from the seventh plane 86, and the fourth leg section 90 lying in a tenth plane 102 substantially parallel to and spaced from the eighth plane 94.

The third leg sections 82 of the sheets 70, 74 include a plurality of third leg portions 106 of the staple blanks 78. The fourth leg sections 90 of the sheets 70, 74 include a plurality of fourth leg portions 110 of the staple blanks 78. The third leg portions 106 are connected to the first leg portions 62 of the staple blanks 78, while the fourth leg portions 110 are connected to the second leg portions 66 of the staple blanks 78.

With reference to the first sheet in FIGS. 4a-4d, the seventh plane 86 containing the third leg portions 106 of the staple blanks 78 forms an angle β with the second plane 34. In addition, in the illustrated embodiment the eighth plane 94 containing the fourth leg portions 110 of the staple blanks 78 forms the same angle β with the third plane 42, however, the angles β need not be the same. As shown in FIGS. 4a-4d, the staple blanks 78 may be partially-formed such that the angle β is between about 5 degrees and about 85 degrees. Particularly, FIG. 4a illustrates a configuration of the staple blanks 78 having an angle β between about 5 degrees and about 25 degrees, and preferably equal to about 15 degrees. FIGS. 4b and 4c illustrate configurations of the staple blanks 78 having an angle β between about 20 degrees and about 40 degrees, and preferably equal to about 30 degrees. FIG. 4d illustrates a configuration of the staple blanks 78 having an angle β between about 50 degrees and about 70 degrees, and preferably equal to about 60 degrees.

With reference to the first sheet 70 in FIGS. 4a and 4b, the first and second leg portions 62, 66 of the staple blanks 78 extend from the crown portion 58 away from the first plane 26, while the third and fourth leg portions 106, 110 of the staple blanks 78 extend from the respective first and second leg portions 62, 66 further away from the first plane 26. In such configurations of the staple blanks 78, the third leg sections 82 of adjacent sheets 70, 74 directly contact one another when the sheets 70, 74 are stacked or nested. Likewise, the fourth leg sections 90 of adjacent sheets 70, 74 directly contact one another when the sheets 70, 74 are stacked or nested. However, the crown sections 22 of adjacent sheets 70, 74 are spaced from one another by a gap G when the sheets are stacked or nested. Comparing the configurations of the nested sheets 70, 74 in FIGS. 4a and 4b, the gap G increases as the angle β increases. Also, as the sheets 70, 74 are stacked or nested, the first leg sections 30 of adjacent sheets 70, 74 become spaced from one another. Likewise, the second leg sections 38 of adjacent sheets 70, 74 become spaced from one another.

With reference to the first sheet 70 in FIGS. 4c and 4d, the first and second leg portions 62, 66 of the staple blanks 78 extend from the crown portion 58 away from the first plane 26, while the third and fourth leg portions 106, 110 of the staple blanks 78 extend from the respective first and second leg portions 62, 66 back toward the first plane 26. In such configurations of the staple blanks 78, the respective crown, first leg, second leg, third leg, and fourth leg sections 26, 30, 38, 82, 90 of adjacent sheets 70, 74 substantially directly contact one another when the sheets 70, 74 are stacked or nested, without forming any substantial gaps between the respective sections 26, 30, 38, 82, 90 of adjacent sheets 70, 74.

The partially-formed staple blanks 18, 78 may be attached to one another by using an adhesive, such as glue, or by other suitable attachment means. Particularly, when the partially-formed staple blanks 18, 78 are “attached” to one another, sheets 10, 14, 70, 74 of the blanks 18, 78 cannot be rolled because the attached leg portions 62 in the second plane 34 and the attached leg portions 66 in the third plane 42 are not coplanar. Therefore, the sheets 10, 14, 70, 74 may be stacked upon one another rather then being rolled. The multiple planes of attachment provide multi-plane rigidity that increases the strength and rigidity of the staple blanks 18, 78 over prior art straight wire blanks.

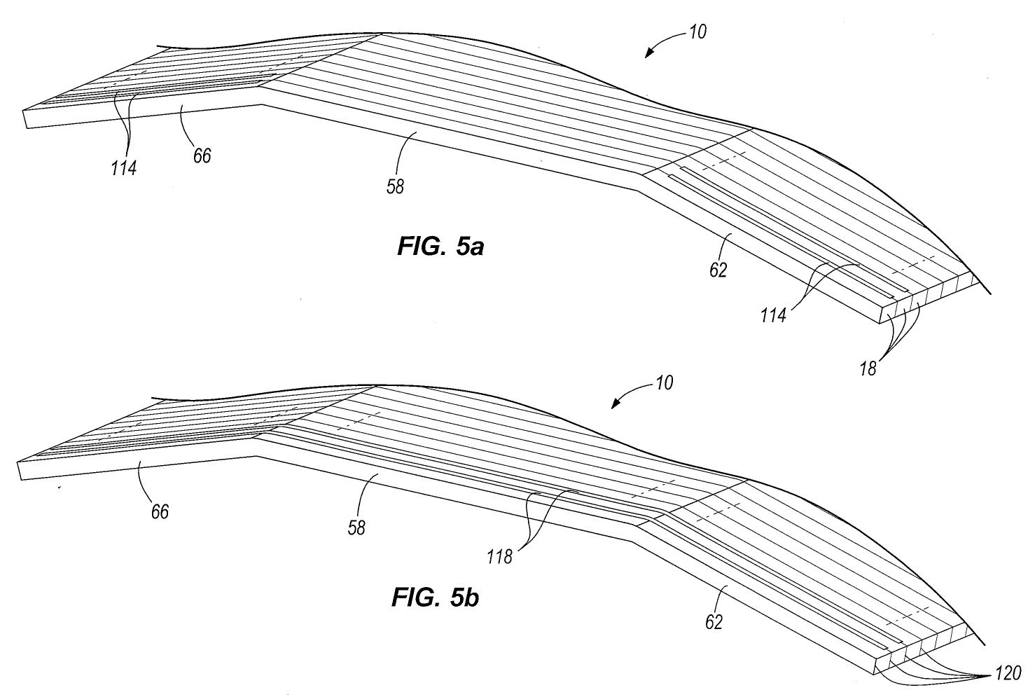

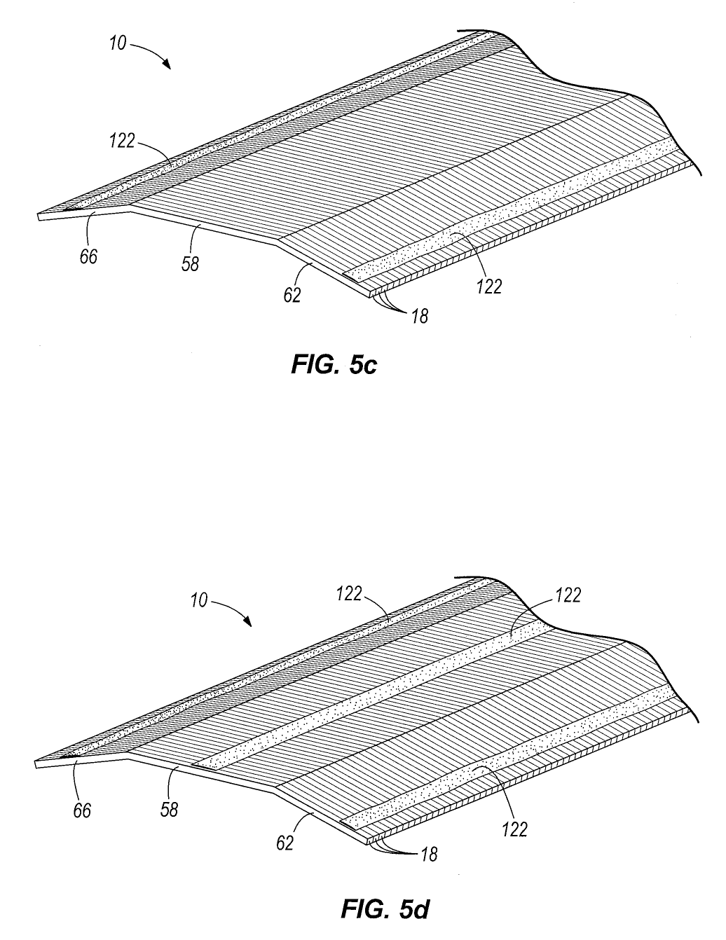

FIGS. 5a-5d illustrate various methods of attaching adjacent staple blanks 18. Although the configuration of the staple blanks 18 of FIG. 1a is shown in FIGS. 5a-5d, the other configurations of single crown staple blanks 18 shown in FIGS. 1b-1e and the configurations of double crown staple blanks 78 shown in FIGS. 3a-3d may also utilize the same methods of attaching adjacent staple blanks 18. FIG. 5a illustrates adjacent staple blanks 18 being attached only at the first and second leg portions 62, 66 by respective beads 114 of glue between adjacent staple blanks 18. Upon attaching adjacent staple blanks 18, the beads 114 of glue may be squeezed toward and onto the tops of the staple blanks 18, as shown in FIG. 5a. Alternatively, as shown in FIG. 5b, adjacent staple blanks 18 may be attached at the crown portions 58 in addition to the first and second leg portions 62, 66 by multiple, discrete beads of glue or by a continuous bead 118 of glue extending across the crown portions 58 and first and second leg portions 62, 66. In other words, adjacent staple blanks 18 may be attached to one another along respective edges 120 extending substantially the entire length of each of the crown portion 58 and the leg portions 62, 66.

FIG. 5c illustrates adjacent staple blanks 18 being attached only at the first and second leg portions 62, 66 by respective strips or beads 122 of glue extending along the length of the sheet 10 of staple blanks 18. Alternatively, as shown in FIG. 5d, adjacent staple blanks 18 may be attached at the crown portions 58 in addition to at the first and second leg portions 62, 66 by respective strips or beads 122 of glue extending along the length of the sheet 10 of staple blanks 18.

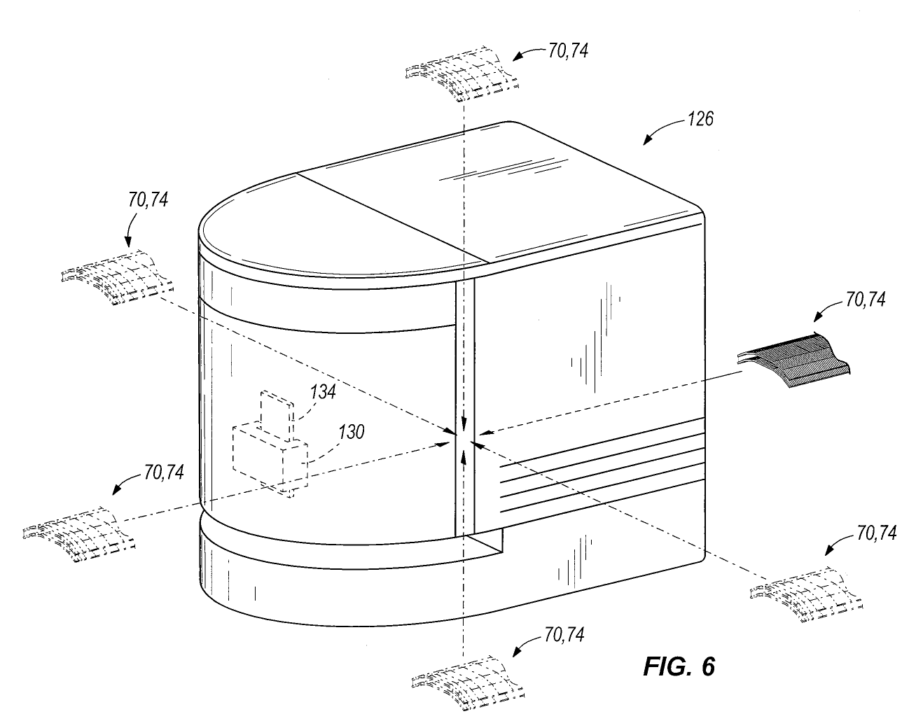

FIG. 6 illustrates an electric stapler 126 which may be utilized with any of the configurations of sheets 10, 14, 70, 74 of partially-formed single crown or double crown staple blanks 18, 78. The electric stapler 126 may include, among other features, an adjustable former assembly 130 and a driver assembly 134. Such an adjustable former assembly 130 and driver assembly 134 may be similar to the adjustable former assembly and driver assembly disclosed in U.S. Pat. Nos. 6,739,492 and 6,871,768, the entire contents of which are incorporated herein by reference. The electric stapler 126 may be configured to load one or more sheets 10, 14, 70, 74 of partially-formed single crown or double crown staple blanks 18, 78 in any of a number of different ways. For example, as shown in FIG. 6, the electric stapler 126 may be configured as a front load, rear load, top load, bottom load, or side load stapler 126.

When sheets 70, 74 of partially-formed double crown staple blanks 78 are utilized with the electric stapler 126, the adjustable former assembly 130 may be actuated by a user between two or more predetermined settings having different length crown portions 58. Since the staple blanks 78 have a fixed overall length, shortening the crown portion 58 yields longer leg portions, while lengthening the crown portion 58 yields shorter leg portions. Allowing a user to select between two or more predetermined settings having different length crown portions 58 eliminates the need for the user to have two different staplers, each having different standard size staples, for stapling smaller stacks of paper (e.g., 30 sheets or fewer) and for stapling larger stacks of paper (e.g., 30 sheets or more), or for the user to switch between different staple sizes in a single stapler.

When a user desires to staple a smaller stack of papers, for example, the user may switch the adjustable former assembly 130 to one of the predetermined crown-width settings providing shorter leg portions. A sheet 70, 74 of staple blanks 78 in the electric stapler 126 may be advanced toward the driver assembly 134, which may separate an individual staple blank 78 from the sheet 70, 74 and drive the individual staple blank 78 toward the former assembly 130. The former assembly 130 may act on the staple blank 78 and form the staple blank 78 according to the selected size of the crown portion 58 or the leg portions 62, 66, 106, 110.

Specifically, as schematically illustrated in FIG. 9a, the former assembly 130 may act on the staple blank 78 to straighten the first and second leg portions 62, 66 to be co-planar with the crown portion 58, and bend the third and fourth leg portions 106, 110 to be substantially perpendicular to the now straightened first and second leg portions 62, 66 and the crown portion 58. The resultant staple would then have legs substantially equal in length to the third and fourth leg portions 106, 110, respectively.

Alternatively, when a user desires to staple a larger stack of papers, for example, the user may switch the adjustable former assembly 130 to one of the predetermined crown-width settings providing longer leg portions. Specifically, as schematically illustrated in FIG. 9b, the former assembly 130 may act on the staple blank 78 to bend the first and third leg portions 62, 106 and the second and fourth leg portions 66, 110, respectively, to be substantially perpendicular to the crown portion 58. The resultant staple would then have legs substantially equal in length to the first and third leg portions 62, 106, and the second and fourth leg portions 66, 110, respectively. In such a configuration of the staple blank 78, the crown portion 58, first leg portion 62, and second leg portion 66 may be collectively referred to as a multi-plane crown portion, in which the first and second leg portions 62, 66 may be bent substantially perpendicularly to the crown portion 58 or the first and second leg portions 62, 66 may be bent substantially co-planar with the crown portion 58.

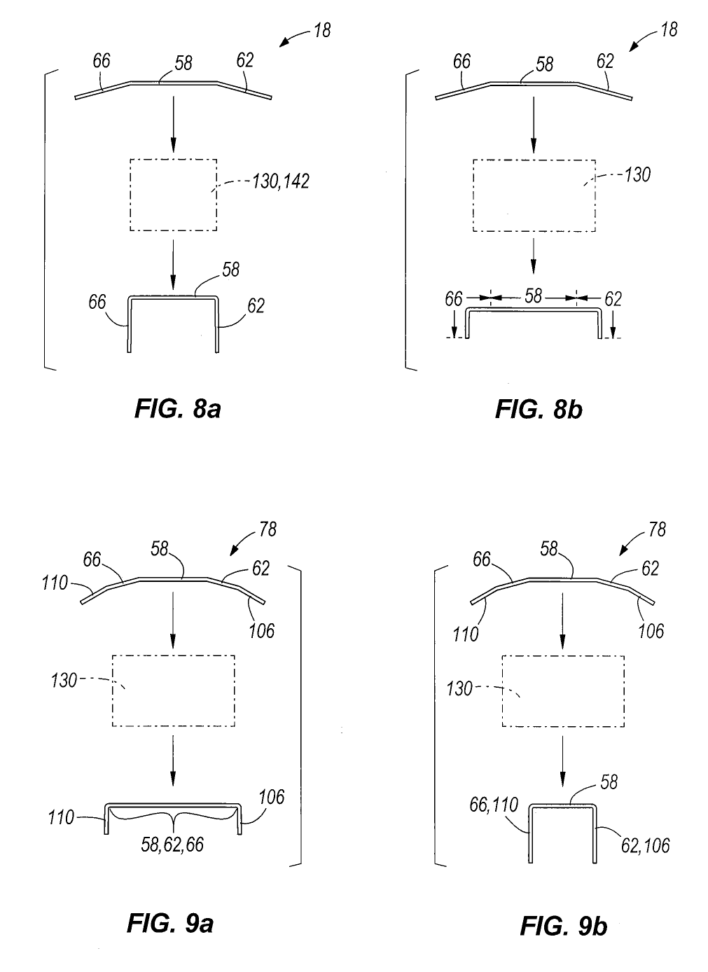

The electric stapler 126 may also utilize sheets 10, 14 of partially-formed single crown staple blanks 18. The adjustable former assembly 130 can be adjusted to the predetermined setting providing staples having legs substantially equal in length to the first and second leg portions 62, 66, respectively. FIG. 8a schematically illustrates the former assembly 130 acting on an individual single crown staple blank 18. The former assembly 130 may act on the staple blank 18 to bend the first and second leg portions 62, 66 to be substantially perpendicular to the crown portion 58. With reference to FIG. 8b, the adjustable former assembly 130 may also be adjusted to provide staples having crown portions of different lengths than that of the crown portion 58. In such an instance, the adjustable former assembly 130 may act on portions of the staple blank 18 not having a pre-formed bend. FIG. 8b illustrates the adjustable former assembly 130 acting on the leg portions 62, 66 of the staple blank 18, forming a staple having a resultant crown portion comprised of the crown portion 58 and portions of the leg portions 62, 66.

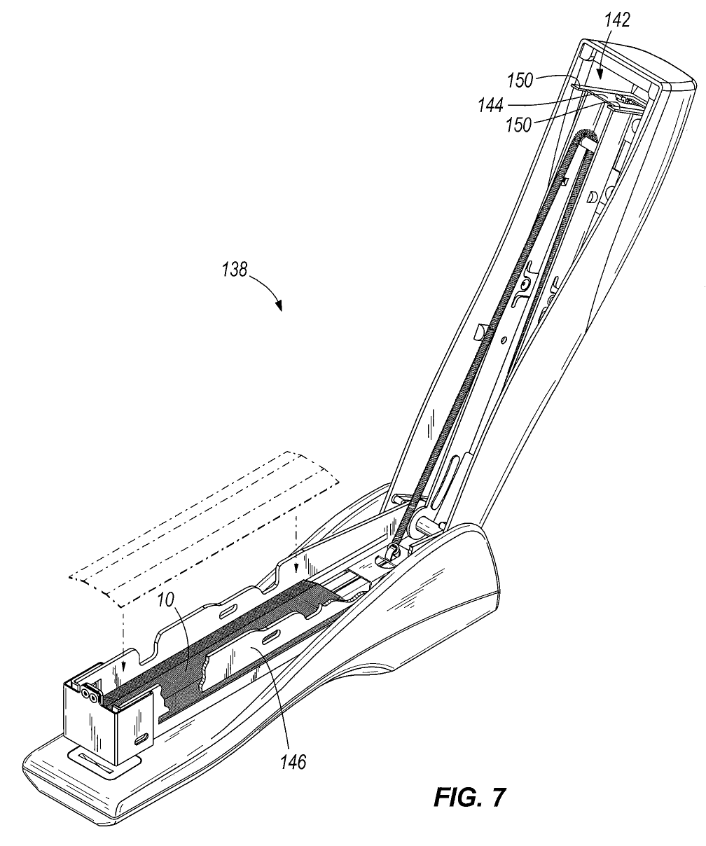

FIG. 7 illustrates a manual stapler 138 which may be utilized with any of the configurations of sheets 10, 14 of partially-formed single crown staple blanks 18. The illustrated manual stapler 138 may include a non-adjustable former assembly 142 configured to act on individual staple blanks 18, a driver 144 configured to separate an individual staple blank 18 from the sheet 10 and drive the individual staple blank 18, and a staple feeding assembly or magazine assembly 146 configured to advance the sheet 10 of partially-formed single crown staple blanks 18 toward the driver 144. As shown in FIG. 7, the magazine 146 is widened to receive the sheet 10 of partially-formed single crown staple blanks 18.

FIG. 8a schematically illustrates the former assembly 142 acting on an individual single crown staple blank 18. The former assembly 142 may act on the staple blank 18 to bend the first and second leg portions 62, 66 to be substantially perpendicular to the crown portion 58. FIG. 7 illustrates one potential configuration of the former assembly 142 on the manual stapler 138. In such a configuration, the former assembly 142 includes a projection 150 on each side of the driver 144. During operation of the manual stapler 138 utilizing sheets 10 of single crown staple blanks 18, the projections 150 may engage the first and second leg portions 62, 66 to bend the leg portions 62, 66 to be substantially perpendicular to the crown portion 58. After the leg portions 62, 66 are bent, the projections 150 may retract or move relative to the driver 150 to allow the driver 150 to act on the formed staple blank 18. Alternatively, other configurations of the former assembly 142 on the manual stapler 138 may be utilized.

The partially-formed staple blanks 18, 78, compared to prior art straight-wire staple blanks, require a reduced amount of force to form the blanks 18, 78 into their final form. As such, the staplers 126, 138 utilizing the partially-formed staple blanks 18, 78 may require a reduced amount of energy to form and drive the partially-formed staple blanks 18, 78. In addition, when the partially-formed staple blanks 18, 78 are attached along their leg portions 62, 66, 106, 110, sheets 10, 14, 70, 74 of partially-formed staple blanks 18, 78 may not be rolled for storage in the staplers 126, 138. Rather, the sheets 10, 14, 70, 74 of partially-formed staple blanks 18, 78 may be nested in the staplers 126, 138 when the leg portions 62, 66, 106, 110 of the blanks 18, 78 define angles between about 5 degrees and about 85 degrees relative to the crown portions 58. More sheets 10, 14, 70, 74, however, may be nested within the staplers 126, 138 when the angles between the leg portions 62, 66, 106, 110 and the crown portions 58 become smaller. The sheets 10, 14, 70, 74 of partially-formed staple blanks 18, 78 are also more structurally rigid compared to prior art sheets of straight-wire staple blanks due to the multiple planes of rigidity enjoyed by the staple blanks 18, 78.

Various features and aspects of the invention are set forth in the following claims.

1. A sheet of partially-formed staple blanks, the sheet comprising:
a first partially-formed staple blank defining a crown portion lying in a crown plane, a first leg portion connected to a first end of the crown portion and lying in a first leg plane forming an angle with the crown plane between about 5 degrees and about 50 degrees, and a second leg portion connected to a second end of the crown portion and lying in a second leg plane different from the first leg plane and forming an angle with the crown plane between about 5 degrees and about 50 degrees; and
a second partially-formed staple blank defining a crown portion lying in the crown plane, a first leg portion connected to a first end of the crown portion and lying in the first leg plane, and a second leg portion connected to a second end of the crown portion and lying in the second leg plane;
wherein the first leg portions of the first and second blanks are attached to one another, and wherein the second leg portions of the first and second blanks are attached to one another.

2. The sheet of partially-formed staple blanks of claim 1, wherein the crown portions of the first and second blanks are attached to one another.

3. The sheet of partially-formed staple blanks of claim 1, wherein the first partially-formed staple blank defines a first edge extending an entire length of each of the crown portion and the first and second leg portions, wherein the second partially-formed staple blank defines a second edge extending an entire length of each of the crown portion and the first and second leg portions, and wherein the first and second partially-formed staple blanks are attached to one another along substantially an entire length of the first and second edges.

4. The sheet of partially-formed staple blanks of claim 1, wherein the first and second leg planes each form an angle with the crown plane between about 5 degrees and about 25 degrees.

5. The sheet of partially-formed staple blanks of claim 1, wherein the first and second leg planes each form an angle with the crown plane between about 20 degrees and about 40 degrees.

6. The sheet of partially-formed staple blanks of claim 1, wherein the first and second partially-formed staple blanks each include a third leg portion connected to the first leg portion and a fourth leg portion connected to the second leg portion, wherein the crown portion, first leg portion, and second leg portion in each of the first and second partially-formed staple blanks comprise a multi-plane crown portion in which the first and second leg portions of the staple blanks are adapted to be one of bent substantially perpendicularly to the crown portions of the staple blanks, and bent substantially co-planar with the crown portions of the staple blanks.

7. An assembly of stacked sheets of partially-formed staple blanks, the assembly comprising:
a first sheet of partially-formed staple blanks, the first sheet including
a crown section lying in a crown plane and containing a plurality of crown portions of staple blanks in the first sheet;
a first leg section adjacent the crown section, lying in a first leg plane, and containing a plurality of attached first leg portions of the staple blanks in the first sheet, the first leg plane forming an angle with the crown plane between about 5 degrees and about 85 degrees; and
a second leg section adjacent the crown section, lying in a second leg plane different from the first leg plane, and containing a plurality of attached second leg portions of the staple blanks in the first sheet, the second leg plane forming an angle with the crown plane between about 5 degrees and about 85 degrees; and
a second sheet of partially-formed staple blanks substantially identical to the first sheet of partially-formed staple blanks, the second sheet of partially-formed staple blanks in nested relation with the first sheet of partially-formed staple blanks.

8. The assembly of claim 7, wherein the plurality of first leg portions in the first leg section of each of the first and second sheets of partially-formed staple blanks are glued to one another, and wherein the plurality of second leg portions in the second leg section of each of the first and second sheets of partially-formed staple blanks are glued to one another.

9. The assembly of claim 7, wherein the plurality of crown portions in the crown section of each of the first and second sheets of partially-formed staple blanks are attached to one another.

10. The assembly of claim 7, wherein the first and second leg planes each form an angle with the crown plane between about 5 degrees and about 50 degrees.

11. The assembly of claim 7, wherein the first and second leg planes each form an angle with the crown plane between about 5 degrees and about 25 degrees.

12. The assembly of claim 7, wherein the first and second leg planes each form an angle with the crown plane between about 20 degrees and about 40 degrees.

13. The assembly of claim 7, wherein the first and second leg planes each form an angle with the crown plane between about 35 degrees and about 85 degrees.

14. The assembly of claim 7, wherein the first leg sections of the first and second sheets directly contact one another, wherein the second leg sections of the first and second sheets directly contact one another, and wherein the crown sections of the first and second sheets are spaced from one another.

15. The assembly of claim 7, wherein the first and second sheets of partially-formed staple blanks each include
a third leg section adjacent the first leg section, the third leg section containing a plurality of attached third leg portions of the staple blanks;
a fourth leg section adjacent the second leg section, the fourth leg section containing a plurality of attached fourth leg portions of the staple blanks;
wherein the crown portions, first leg portions, and second leg portions in each of the first and second sheets of partially-formed staple blanks comprise multi-plane crown portions in which the first and second leg portions of the staple blanks are adapted to be one of bent substantially perpendicularly to the crown portions of the staple blanks, and bent substantially co-planar with the crown portions of the staple blanks.

16. A stapler comprising:
a sheet of partially-formed staple blanks including
a first partially-formed staple blank defining a crown portion lying in a crown plane, a first leg portion connected to a first end of the crown portion and lying in a first leg plane forming an angle with the crown plane between about 5 degrees and about 85 degrees, and a second leg portion connected to a second end of the crown portion and lying in a second leg plane different from the first leg plane and forming an angle with the crown plane between about 5 degrees and about 85 degrees;
a second partially-formed staple blank defining a crown portion lying in the crown plane, a first leg portion connected to a first end of the crown portion and lying in the first leg plane, and a second leg portion connected to a second end of the crown portion and lying in the second leg plane, the first leg portions of the first and second blanks are attached to one another, and the second leg portions of the first and second blanks are attached to one another;
a staple feeding mechanism that feeds the sheet of partially-formed staple blanks in a staple feed direction; and
a staple former assembly for bending the first leg portions of the staple blanks to an angle of about 90 degrees between the first leg portions and the crown portions, and bending the second leg portions of the staple blanks to an angle of about 90 degrees between the second leg portions and the crown portions.

17. The stapler of claim 16, wherein the crown portions of the first and second blanks are attached to one another.

18. The stapler of claim 16, wherein the first partially-formed staple blank defines a first edge extending an entire length of each of the crown portion and the first and second leg portions, wherein the second partially-formed staple blank defines a second edge extending an entire length of each of the crown portion and the first and second leg portions, and wherein the first and second partially-formed staple blanks are attached to one another along substantially an entire length of the first and second edges.

19. The stapler of claim 16, wherein the first and second leg planes each form an angle with the crown plane between about 5 degrees and about 25 degrees.

20. The stapler of claim 16, wherein the first and second leg planes each form an angle with the crown plane between about 20 degrees and about 40 degrees.

21. The stapler of claim 16, wherein the first and second leg planes each form an angle with the crown plane between about 35 degrees and about 85 degrees.

22. The stapler of claim 16, wherein the first and second leg planes each form an angle with the crown plane between about 5 degrees and about 50 degrees.

23. The stapler of claim 16, wherein the staple former assembly is movable between a first position for forming staples having a first crown size substantially similar to the crown portions of the staple blanks and a second position for forming staples having a second crown size greater than or less than about the length of the crown portions of the staple blanks.

24. The stapler of claim 16, wherein the first and second partially-formed staple blanks each include a third leg portion connected to the first leg portion and a fourth leg portion connected to the second leg portion, wherein the crown portion, first leg portion, and second leg portion in each of the first and second partially-formed staple blanks comprise a multi-plane crown portion in which the first and second leg portions of the staple blanks are adapted to be one of bent substantially perpendicularly to the crown portions of the staple blanks, and bent substantially co-planar with the crown portions of the staple blanks.

25. The stapler of claim 24, wherein the staple former assembly is movable between a first position, in which the first and second leg portions of the staple blanks are bent relative to the crown portions to an angle of about 90 degrees, and a second position, in which the third and fourth leg portions of the staple blanks are bent relative to the crown portions, the first leg portions, and second leg portions to an angle of about 90 degrees.

26-33. (canceled)
